(19) United States
(12) Patent Application Publication
(10) Pub. No.: US 2018/0049849 A1
(43) Pub. Date: Feb. 22, 2018

(54) DIGITAL FULL ARCH APPARATUS AND METHOD FOR IMMEDIATE DEFINITIVE DENTAL PROSTHESES

(71) Applicant: Hybridge Dental Lab LLC, Rochester, NY (US)

(72) Inventors: Frank R. Lamar, Pittsford, NY (US); Tom Lake, Rochester, NY (US); Christopher C. Fox, Pittsford, NY (US)

(21) Appl. No.: 15/681,362

(22) Filed: Aug. 19, 2017

Related U.S. Application Data
(60) Provisional application No. 62/377,564, filed on Aug. 20, 2016.

(51) Int. Cl. A61C 8/00

(52) U.S. Cl. CPC A61C 8/0009; A61C 8/0093; A61C 8/001; A61C 8/0089

(57) ABSTRACT

The apparatus and methods disclosed utilize a healing assembly including a prosthetic shoe and a healing sleeve that, when used in mating combination, allow the radiographic capture of the prosthetic shoe as it relates to the dental implant surface(s) and the exact orientation of the final prosthetic tooth set-up to provide all information required in one step, for final CAD/CAM of the final fixed implant supported prosthetic bridge.

This application claims priority under 35 U.S.C. §119(e) to U.S. Provisional Patent Application No. 62/377,564 for DIGITAL FULL ARCH APPARATUS AND METHOD FOR DENTAL PROSTHESES, by F. Lamar et al., filed Aug. 20, 2016, which is hereby incorporated by reference in its entirety.

The apparatus and methods disclosed herein permit the efficient design and installation of a fixed bridge type dental prosthesis without customary try-ins, model verification jigs, setups and other prosthetic validation steps. The prosthesis design includes radiographic scanning of a patient's jaw and mouth, including features such as dental implants, associated prosthetic shoes, final prosthetic tooth set-up, as well as tissue surfaces to facilitate the immediate loading (days-weeks) of a dental prostheses (e.g., fixed bridge type) into the mouth, thereby further reducing the delay and the number of steps needed in the clinical and dental laboratory settings to fabricate and install the prostheses and complete the patient's treatment.

### BACKGROUND AND SUMMARY

Crowns and removable bridges have often been the approach to preserving diseased teeth or replacing lost teeth. However, such devices tend to fail due to the genetic predisposition of tooth decay and periodontal disease that natural teeth cause in some high risk patients. As a result patients often experience an endless cycle of dental work, with the risk that each procedure increasingly limits dental function and compromises quality of life.

As a solution to such problems, the hybrid fixed bridge (e.g., Hybridge™ and other brands) has been developed. Such a bridge replaces all of the patient's upper and/or lower teeth. The fixed bridge is permanently supported on multiple (typ. 4 or more) dental implants and looks, feels and functions like healthy, natural teeth, and also preserves the jaw bone as a result of stimulation of the bone supporting the implants, thereby preventing bone loss and preserving facial appearance.

It is not uncommon to utilize threaded implants to support fixed-detachable dentures and other prostheses within a patient's mouth. Also, threaded dental implants have been used to support prostheses at or shortly after the time the implants are placed. For example, P. A. Schnitman et al. (Int-J-Oral-Maxillofacial-Implants. 1997 Jul.-Aug. 12(4):495-503), D. P. Tarnow et al. (Int-J-Oral-Maxillofacial-Implants. 1997 May-Jun.: 12(3):319-24) and G. Kammeter et al. (J Prosthetic Dent. 2001 May; 87(5):473-476) have all described “immediate loading” of implants. For example, the term “immediate denture” is also defined by The Academy of Prosthodontics (THE JOURNAL OF PROSTHETIC DENTISTRY; THE GLOSSARY OF PROSTHODONTIC TERMS (GPT-9), Ninth Ed., May 2017, p. e47) as “any fixed or removable dental prosthesis fabricated for placement immediately following the removal of a natural tooth/teeth” or dentition. The embodiments disclosed herein advocate placing a final, definitive prosthesis with an “early” or “progressive loading” protocol, where initially, a temporary denture is placed on the implants (the provisional) and subsequently the definitive prosthesis is placed. Loading of fixed hybrid bridges (within 2-3 weeks of surgery), using the techniques disclosed herein for immediate and early loading, are believed to be more predictable, easier, more cost effective, with less steps, and more precise for a number of reasons, including the manner of preparing for (impressions, radiographic scans, etc.), simultaneously establishing tooth position, time for producing and installing temporary and definitive fixed hybrid bridges, etc. An exemplary disclosure of such a system and methodology is found, for example, in published U.S. Patent Application 2009/0081618 for a SYSTEM AND METHOD FOR IMMEDIATE LOADING OF FIXED HYBRID DENTAL PROSTHESES, by Frank R. LaMar, published Mar. 26, 2009, which is hereby incorporated by reference in its entirety. Moreover, the improved techniques and protocols for edentulous mandibles and maxillas as disclosed herein are not believed to have been previously considered.

The timely completion of a fixed hybrid bridge is desirable by many patients. Moreover, aspects of the hybrid bridge system and methodology, as disclosed in detail herein, provides a fixed restoration that may be preferred by many patients, provides improved masticatory function, provides improved aesthetics with ideal gingival contours, and importantly is cost effective as it only requires about five to six implants and uses a simplified technique. Most patients are candidates depending upon the quantity of bone in the symphysis of the mandible and the premaxilla of the maxilla. Once a patient is evaluated for a fixed hybrid bridge, one of the treatment protocols disclosed below may be completed in a timely manner to assure a successful outcome. Moreover, the embodiments disclosed below provide the added value of digital capture of physical patient information—such as implant location and orientation relative to bone, tissue, and teeth—as a means to substantially shorten the time, and the number of patient appointments, to design, manufacture and install a dental prosthetic(s) for a patient.

Disclosed in embodiments herein is a healing assembly, for use in a dental implant procedure on a patient's alveolar tissue (e.g., mandible or maxilla), comprising: a prosthetic shoe for attachment to the dental implant; and a healing sleeve, removably mated with said prosthetic shoe, said healing sleeve having a generally cylindrical outer surface.

As part of disclosed embodiments, the prosthetic shoes are initially attached to implants to facilitate imaging, design of a prosthesis, and the installation of healing sleeves after implants are installed, and then the shoes (or identical equivalents) end up being the means by which the full prosthesis is attached to the implants. In other words the prosthetic shoes are adhered to and become an integral part of the prosthesis.

Further disclosed in embodiments herein is an apparatus for use with a plurality of dental implants inserted as a precursor to the attachment of a fixed bridge to said implant, comprising: a prosthetic shoe for attachment to each dental implant; and a healing sleeve, removably mated with said prosthetic shoe, said healing sleeve having a generally cylindrical outer surface, wherein said prosthetic shoe and said healing sleeve each have at least one tapered mating surface feature to assure the relative position of the healing sleeve to the prosthetic shoe, where the prosthetic shoe is tapered on at least one exterior surface thereof and where the one mating feature includes a tapered interior surface on the healing sleeve, said tapered interior surface matching the taper of the exterior surface of said prosthetic shoe.

Disclosed herein is an apparatus, for use in a dental implant procedure, comprising a healing cap, said healing being suitable for removable mating with a prosthetic shoe that may be attached to a dental implant, said healing cap including: a generally cylindrical outer surface on a least a portion thereof, said cylindrical outer surface including a first annular groove about a bottom portion of the healing sleeve outer surface, and a second, larger annular groove adjacent a radiused top portion of the healing sleeve outer surface to form a bulbous top on the healing cap outer surface, at least one interior mating surface feature to assure a relative position of the healing cap to the prosthetic shoe, where the at least one mating feature includes a tapered interior surface on the healing cap, said tapered interior surface generally matching a taper of an exterior surface of said prosthetic shoe; and at least one feature protruding from an interior surface of said healing cap, said at least one feature suitable for engaging a feature of the prosthetic shoe to removably attach the healing cap to the prosthetic shoe.

Also disclosed herein is a method of preparing at least one dental implant suitable for retaining a dental prosthesis within a patient's mouth, comprising: inserting a dental implant into the patient's alveolar tissue (mandible or maxilla); attaching a prosthetic shoe to the dental implant, said prosthetic shoe having an exterior surface with at least one annular groove thereabout; and temporarily affixing, in a mating relationship with the prosthetic shoe, a healing sleeve having a generally cylindrical outer surface on at least a first end of the healing sleeve and a tapered interior surface on the interior surface of the first end, said tapered interior surface matching the taper of the prosthetic shoe when said healing sleeve is affixed thereon; wherein said combination of the prosthetic shoe and the healing sleeve further prevents the post-insertion overgrowth of gingival tissue over the implant.

Further disclosed in embodiments herein is a method of preparing for installation of a fixed bridge-type dental prosthesis within a patient's mouth, comprising: inserting a plurality of dental implants into the patient's alveolar tissue (mandible or maxilla); attaching a prosthetic shoe to each of the dental implants, said prosthetic shoes each having a tapered exterior surface with at least one annular groove thereabout; and temporarily affixing, to each of the prosthetic shoes, a healing sleeve having a generally cylindrical outer surface on a first end of the healing sleeve and a tapered interior surface on the interior surface of the first end, said tapered interior surface matching the taper of the prosthetic shoes when said healing sleeves are affixed thereon; wherein the combination of the prosthetic shoes and respective healing sleeves further prevent the post-insertion overgrowth of gingival tissue over the implants. In accordance with a further aspect of the disclosed embodiments, the healing sleeves may be radiographically translucent, which provides the ability to take a digital radiographic image of the underlying prosthetic shoe (affixed to the implant) immediately after surgery and thereby facilitate the accurate and immediate manufacture of the dental prosthetic.

### BRIEF DESCRIPTION OF THE DRAWINGS

FIG. 1 is an exemplary illustration of a healing assembly for use with a dental implant in accordance with an aspect of the disclosed embodiments;

FIGS. 2, 3 and 4A-4B are illustrations of various embodiments of the prosthetic shoe and healing sleeve of FIG. 1;

FIGS. 5A-5C are detailed views of the prosthetic shoe of FIG. 1;

FIG. 6 is an illustrative example of a digital image obtained from a computer tomography (CT) scan of a patient's mouth;

FIGS. 7-11 are exemplary CAD/CAM designs and simulations illustrating the installation of a fixed bridge type prosthesis in relation to a patient's mandible; and

FIGS. 12A-12D are illustrative examples of a final bridge (dental prosthesis) in accordance with an aspect of the disclosed embodiments.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

As used herein, the following terms and acronyms are intended to have the meaning indicated, however, such terms are used as illustrative examples and are not intended to limit the scope of the disclosed embodiments:

Prosthetic Tooth Set-up: A predetermined mock-up of the anticipated tooth position and final tooth contours, typically in the form of a removable denture.

Fixed Hybrid Bridge: the name usually referred to when referring to a “Full Arch, screw retained, implant supported, fixed bridge.

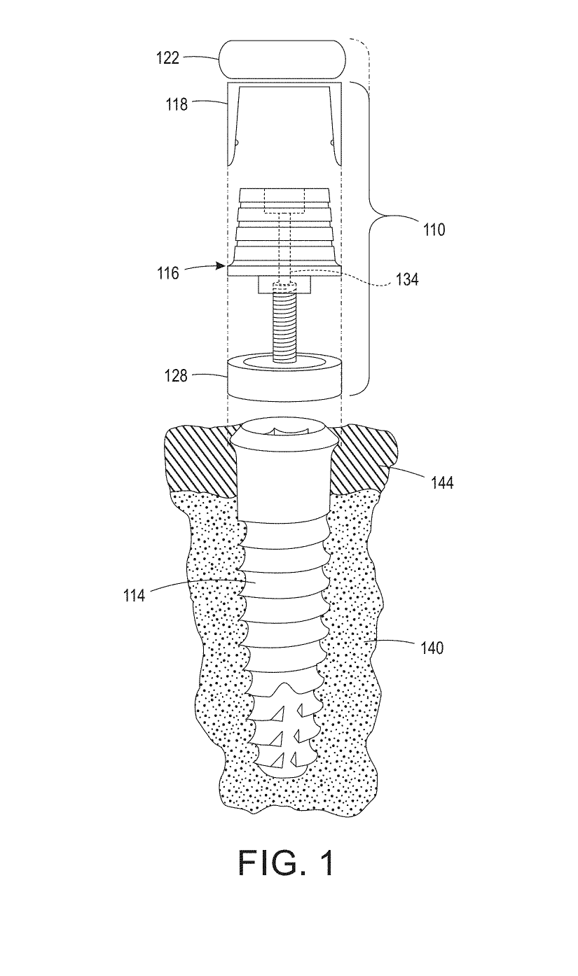

Referring to FIG. 1, depicted therein is a healing assembly 110, for use in a dental implant procedure on a patient's alveolar tissue 140 such as the mandible or maxilla. The healing assembly 110 comprises a prosthetic shoe 116 for placement on the dental implant 114 (e.g., a tapered tissue-level implant such as #TTLY3810 from Biohorizons), and a healing sleeve 118. The healing sleeve 118 is removably mated to the prosthetic shoe, and the healing sleeve provides a generally cylindrical outer surface 120, over at least a lower portion of the healing sleeve, for the patient's gingival tissue 144 to heal around.

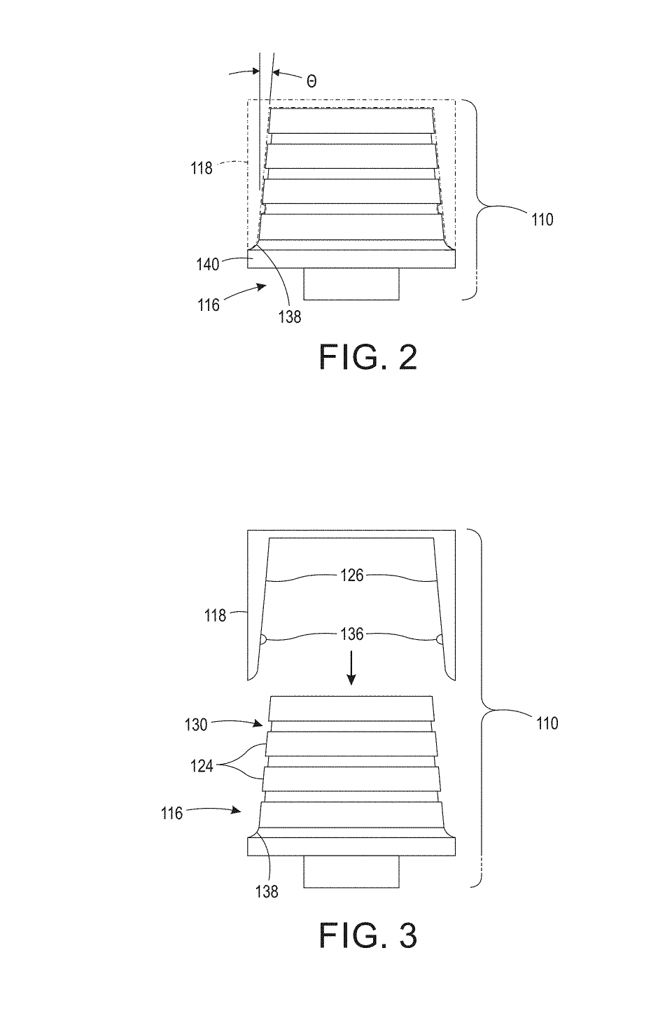

Referring also to FIGS. 2-3, in the healing assembly 110, the prosthetic shoe 116 and the healing sleeve 118 each have at least one mating surface feature to assure the relative position of the healing sleeve to the prosthetic shoe. As depicted, the prosthetic shoe is tapered on at least one exterior surface 124 thereof and the mating feature(s) includes a tapered interior surface 126 on the healing sleeve, where the tapered interior surface generally matches the taper (angle) of the exterior surface of said prosthetic shoe. The taper (θ) of the prosthetic shoe is an angle of about 5-degrees, but could be slightly less or greater, in the range of 1-degree to about 10-degrees. Not only does the taper permit other components to be easily attached over the tapered surface, but the taper further facilitates the installation of the final prosthesis, as will be described below, particularly when the implants are not all fully aligned with one another. For further assuring that a sleeve or prosthesis is fully attached or adhered to the prosthetic shoe, the bottom portion of the shoe includes a curved transition or chamfer 138 to the generally cylindrical shoulder region 140 near the bottom of shoe 116. The curved transition region 138 avoids an abrupt shoulder that might prevent the full insertion of the shoe with a mating component.

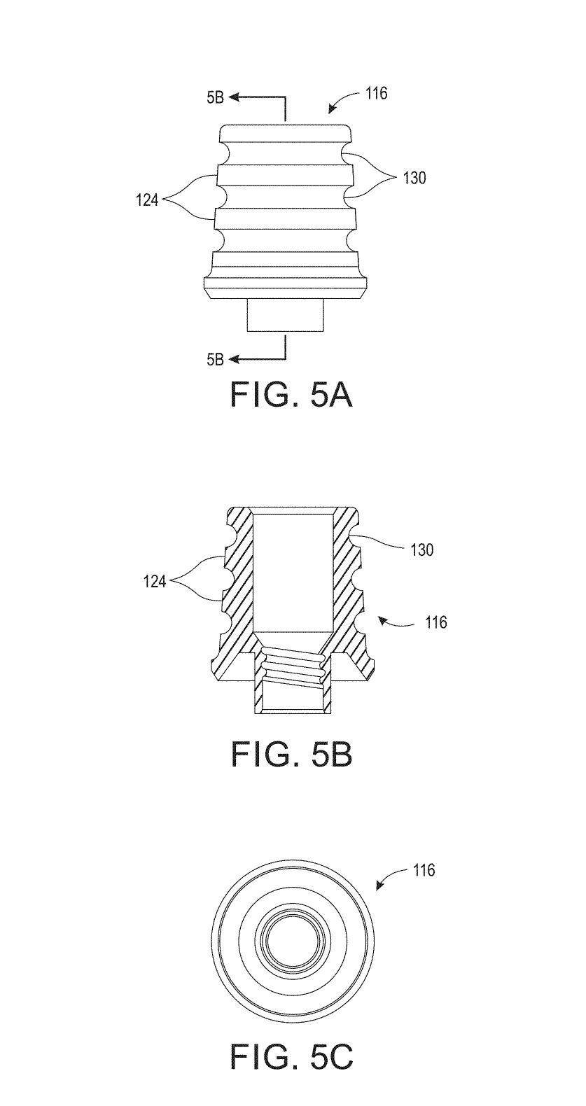

In one embodiment, the prosthetic shoe 116 includes at least one annular groove 130 about an outer surface thereof. The groove may have a squared or radiused bottom profile. Moreover, prosthetic shoe 116 may be reused during attachment of a prosthesis to the dental implant, where the annular groove(s) provides a surface by which the prosthetic shoe is adhered to the prosthesis. FIGS. 5A-5C provide illustrations of one embodiment of the prosthetic shoe 116, and it will be appreciated that the interior dimensions of the healing sleeve would be similar to the exterior dimensions of the shoe. Although an embodiment of the prosthesis is described in more detail below, in one embodiment it may be a fixed bridge formed, at least in part, using a polymethyl methacrylate (PMMA) or other appropriate millable material known for dental use.

As illustrated in FIG. 2, for example, the healing sleeve 118 further includes at least one engagement feature 136 for engaging or locking with the prosthetic shoe 116, whereby upon pushing the healing sleeve over the prosthetic shoe as indicated by the arrow, the feature engages an annular groove of the prosthetic shoe to removably attach the healing sleeve to the prosthetic shoe. As depicted, the engagement feature may include a bump(s) or annular ridge extending inward from the interior surface of the healing sleeve 118, or it may be a split or partial ring extending about the interior of the healing sleeve in a concentric manner. Use of such a feature enables the prosthetic shoe 116 and healing sleeve 118 to be placed together in a “mated” fashion, and to further permit the shoe and healing sleeve to fit in a snap-together relationship.

As will be appreciated, to facilitate its flexibility relative to the attachment to the prosthetic shoe, the healing sleeve may be made from a non-metallic material such as a “plastic”. While a number of plastic materials may be employed, and the method of manufacture may include machining (CNC, screw machine, etc.) and molding, the particular process used is not believed to be critical and may be largely dependent upon the material used for the healing sleeve. In one embodiment, to facilitate the design and placement of a Fixed Bridge Type prosthesis, the healing sleeve 118 may be formed of a non-metallic material such as an engineering thermoplastic, or more particularly an acetal homopolymer resin such as Delrin® by Dupont or an ultra-high performance biocompatible thermoplastic such as polyaryletherketone (e.g., TECAPEEK Classix™ or PEEK Optima™ available from Ensinger Ltd. or Invibio® Ltd). Moreover, the “radiotranslucent” or radiographically translucent (or possibly even radiographically opaque) material provides an added advantage of enabling the radiographic imaging of the patient's tissue, implants, prosthetic teeth positions, and associated prosthetic shoes with the healing sleeves in place, thereby eliminating or at least reducing costly and time-consuming steps conventionally required for the design and installation of a fixed bridge prosthetic device to the dental implants.

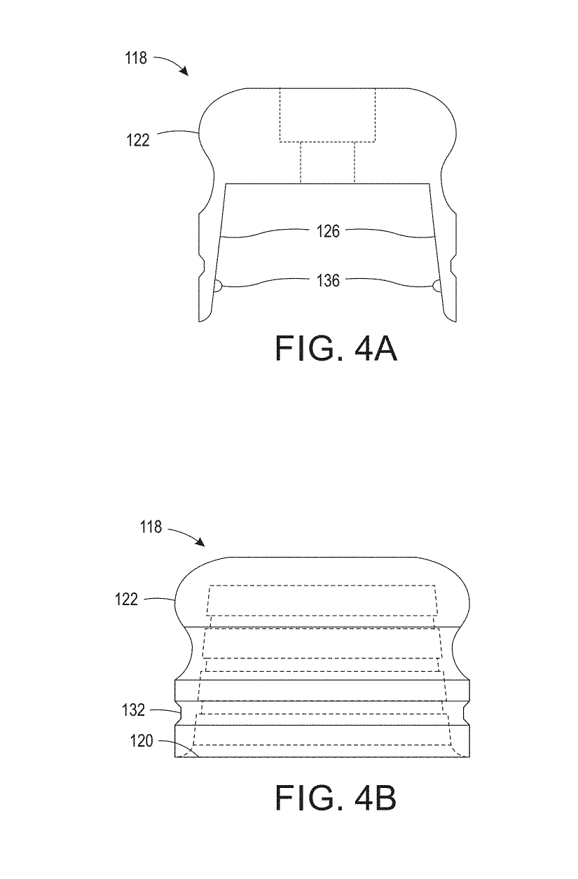

As further illustrated in FIGS. 1 and 4A-4B, healing sleeve 118 includes a bulbous or bulb-shaped outer surface 122 on a top end thereof. In one embodiment, the bulb is part of the top or upper end of the healing sleeve 118, such as depicted in FIGS. 4A and 4B. In an alternative embodiment, also contemplated, as depicted in FIG. 4A, the bulb shape is an extension, and may be a separate component, of the healing sleeve 118, which assists in the orientation of the “prosthetic tooth set-up” required in the image capture to the prosthetic shoe 116 and therefore the implant 114. As further illustrated in FIG. 1, the various components may be maintained in position using a screw 134 that has an upper shoulder and a lower end that is threadably engaged within the interior of the implant. One reason the healing sleeve is preferably radiolucent, is so that when applied over the prosthetic shoe a CT scan will only “see” the surface of the prosthetic shoe, and at the same time the healing sleeve with bulb acts as an indexer to the shoe surface and the prosthetic tooth set-up.

As described above relative to FIGS. 1-4, the healing sleeve is removably mated with the prosthetic shoe, and the healing sleeve has a generally cylindrical outer surface over at least its lower portion so that it can provide a surface against which gingival tissue may heal after implant surgery. The outer surface of the healing sleeve may also include other features that are advantageous, such as a suture line or groove 132 in which a suture may be placed or routed and to facilitate the healing of gingival tissue about the implant. And, although the mating surface between the prosthetic shoe and said healing sleeve is depicted as a tapered mating surface, there may be alternative shapes or other mating features that could be suitable to assure an accurate mating relationship between the two components.

As represented in FIG. 1, implant 114 is described as a tissue level dental implant. It should be appreciated however, that aspects of the disclosed embodiments may be similarly applicable to implants that are placed in a different relationship to the gingival or alveolar tissue. For example, in an embodiment where a bone-level (below tissue surface) implant is employed, a tissue collar 128 or similar component may be placed directly on the top of the implant 114 and then the prosthetic shoe may similarly be placed onto the tissue collar. In this case as well, a threaded screw 134 or similar fastener may be employed to assure that the prosthetic shoe and the tissue collar are attached to the implant. Accordingly, the prosthetic shoe can also be mated to a multi-unit abutment, or in other words an attachment(s) that sits on the implant to change the orientation angle and/or height of the implant interface. In summary, for bone-level implants it is possible to employ tissue collars, tissue cuffs, extenders, multi-unit abutments and the like to bring the prosthetic shoe interface at or above the tissue surface, and these alternatives could still be applied in the manner and using the component disclosed herein.

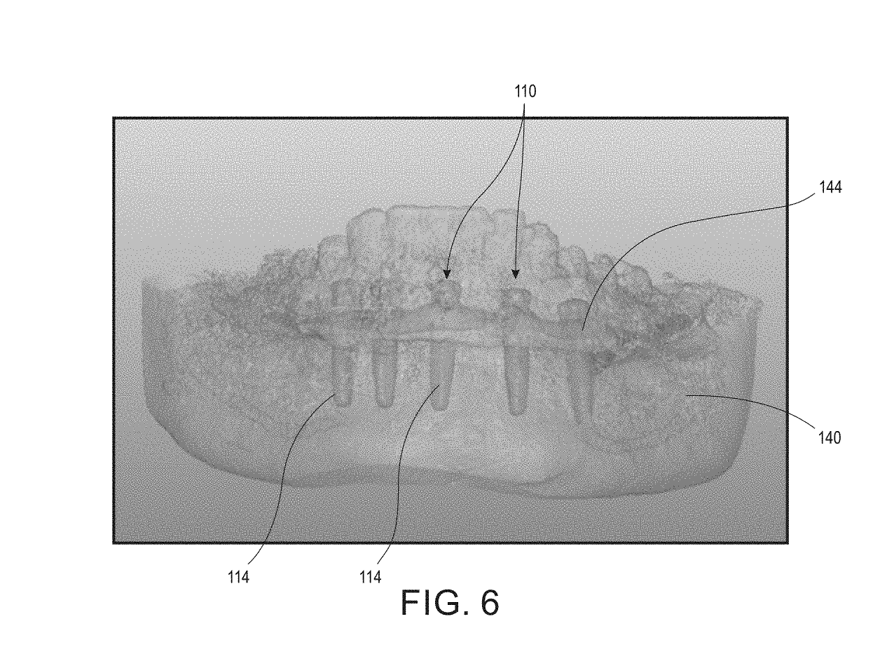

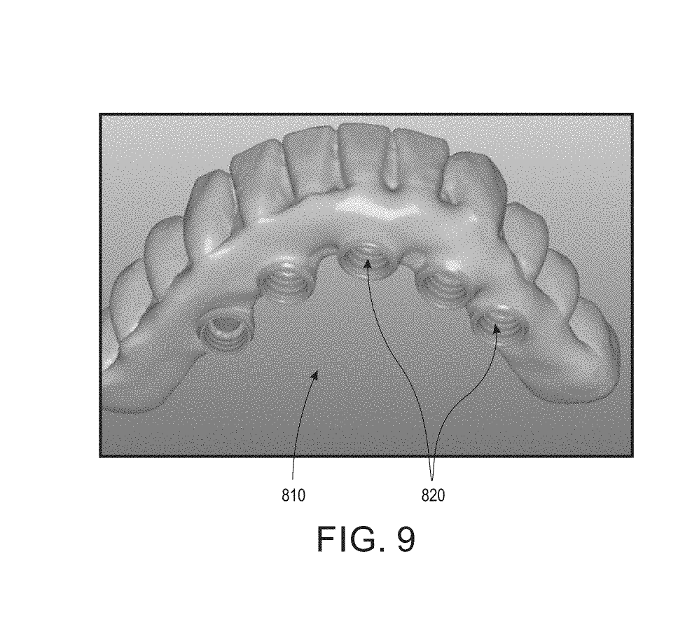

Referring next to FIGS. 6-10, attention is now turned to the description of a process in which the two-part healing assembly 110 may be used. As has been suggested above, the basic method of use is directed to preparing at least one dental implant 114 for retaining a dental prosthesis (e.g., FIG. 9) within a patient's mouth. The method includes inserting the dental implant(s) 114 into the patient's alveolar tissue (mandible or maxilla), attaching a prosthetic shoe 116 to the dental implant, the prosthetic shoe having an exterior surface with at least one annular groove thereabout; and at least temporarily affixing, in a mating relationship with the prosthetic shoe, a healing sleeve 118 having a generally cylindrical outer surface on at least a first (e.g., lower) end of the healing sleeve and a tapered interior surface on the interior surface of the first end, where the tapered interior surface matches or mates to the taper of the prosthetic shoe when the healing sleeve is affixed thereon. As noted previously, the combination of the prosthetic shoe and the healing sleeve form a healing assembly that further prevents the overgrowth of gingival tissue over the implant post-insertion.

As represented in FIG. 2, for example, temporarily affixing the healing sleeve 118 to the prosthetic shoe 116 causes the engagement feature, such as a bump(s) or annular ridge on the interior surface, to engage an annular groove 130 of the prosthetic shoe, for example, where the engagement feature seats into the groove 130. Once the bump(s) or ridge is seated into the grove, the healing sleeve is locked to the prosthetic shoe so as to removably join the healing sleeve to the prosthetic shoe. And, as was characterized by FIG. 1, attaching the shoe to the dental implant may further include a connector such as a screw 134 passing through the center of the shoe for threadably engaging an inner surface of the dental implant 114. It will be appreciated that alternative methods of associating or affixing the healing sleeve to the prosthetic shoe are possible, including a threaded engagement directly between the two.

As suggested above, the use of a radiographically transparent material for the healing sleeves enables the radiographic imaging of the patient's mouth, including the prosthetic tooth position, the implants, prosthetic shoes and tissue surfaces as illustrated, for example, in FIG. 6. FIG. 7 illustrates the placement of dental implants in a patient's alveolar tissue. For example, the radiographic imaging depicted in FIG. 6 may subsequently be employed to isolate the patient's gingival tissue surface (144) such as represented by numeral 744 in FIG. 7, where the upper surface of the implants 114 are in view. One method of use of the disclosed prosthetic shoes and healing sleeves contemplates removing the healing sleeve from the prosthetic shoe, after the gingival tissue has healed around the dental implant, by applying upward force to the healing sleeve sufficient to displace the feature from the annular groove. This operation reveals the underlying, tapered surface of the prosthetic shoe with its annular groove(s). And, the prosthesis may then be permanently affixed directly to the prosthetic shoe(s), or an identical replacement set of equivalent shoes as described below, thereby facilitating attachment of the prosthetic shoe and prosthesis to the dental implant using a connector or similar fastener (e.g., a screw).

Although it will be appreciated that various features may be presented on the outer surface of the prosthetic shoe to facilitate binding or adhesion to the prosthesis, the illustrated embodiment employs multiple annular grooves 130, concentrically located about the tapered exterior surface of the prosthetic shoe.

This configuration, and the details of the grooves themselves, are shown in detail in the drawings of FIGS. 5A-5C.

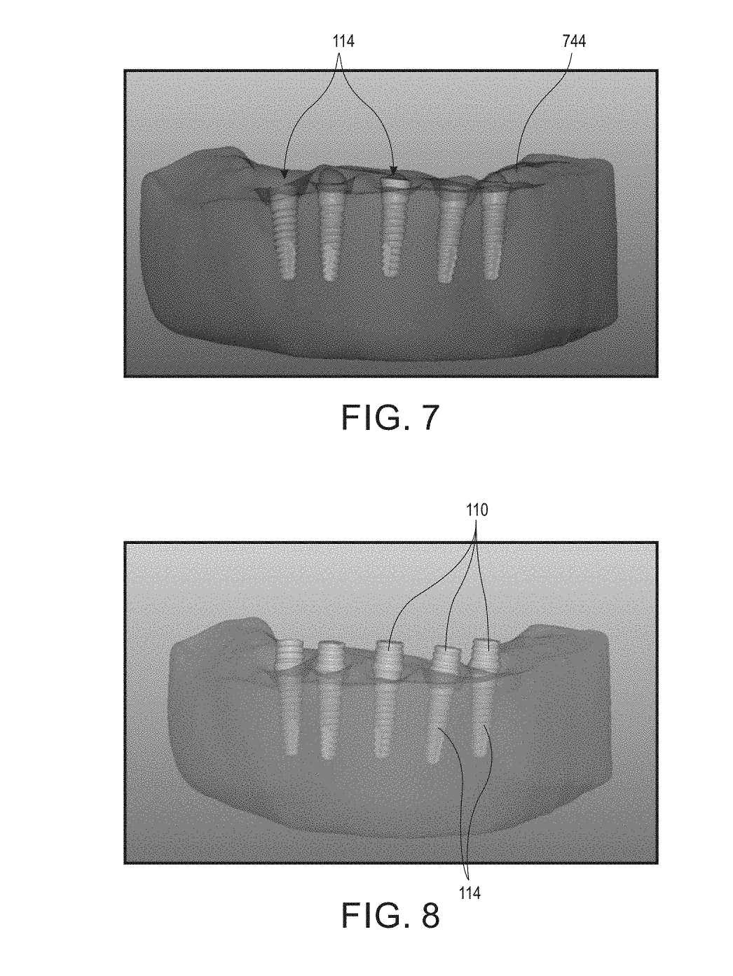

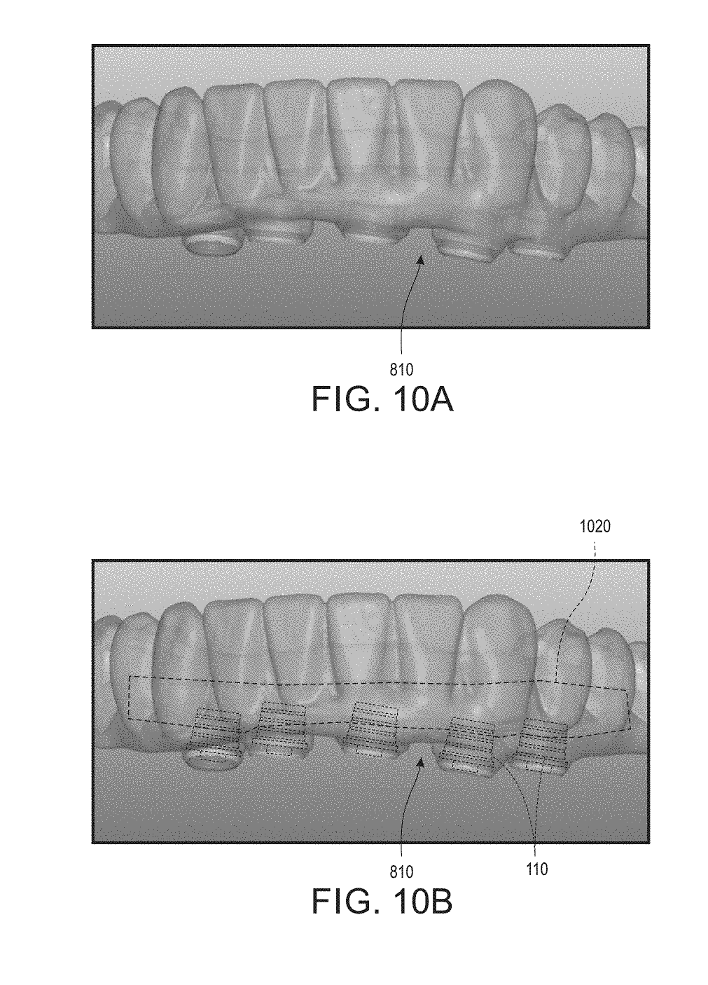

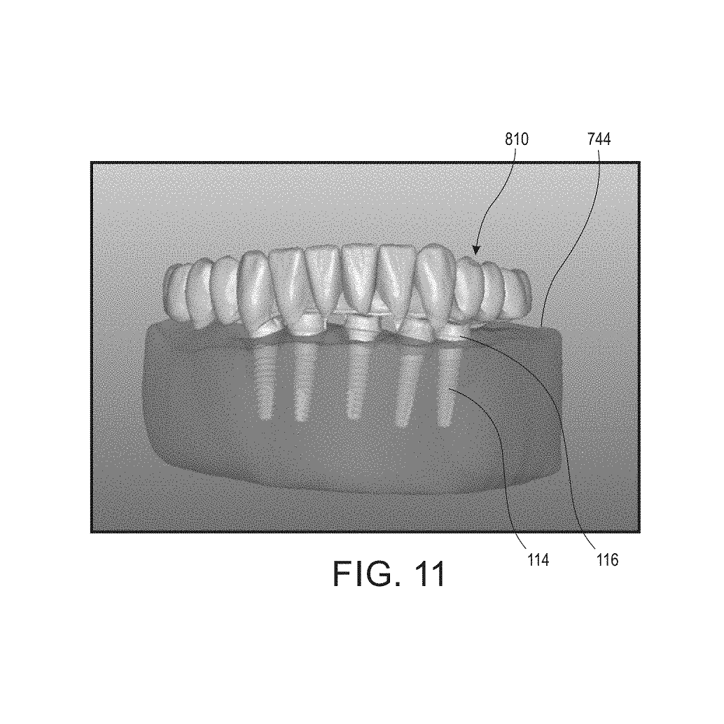

Referring next to remaining FIGS. 7-11, depicted therein are successive illustrations derived from both computerized tomography (CT) scan radiographic images (FIG. 6) and computer-assisted design (CAD) illustrations derived from a dental design software (FIGS. 7-11) of process steps and the resulting imagery and associated designs that may be employed relative to the fabrication and installation of the prosthesis (full bridge) as represented, for example, in FIGS. 9-10A). Reference is also made to FIG. 8, which illustrates a prosthetic shoes mechanically fastened or attached to the dental implants 114. For example, as represented by FIG. 8, a dental design (CAD/CAM) system, such as that available from Zirkonzahn, may be employed to detect and isolate the positions of the implants as well as the prosthetic shoes 116 attached thereto (lying below the radiotranslucent healing sleeves) to provide a multi-dimensional model of the patient's mouth post-implant. The CAD model of FIG. 8 is then employed to create a mock-up or model 810 of the patient's prosthesis (e.g., tooth surfaces), where the CT image data of the gingival surface, prosthetic shoe positions, prosthetic tooth setup, etc. are employed to prepare the design of the prosthesis. An example of the prosthesis model is depicted, for example in FIG. 9, and illustrates the mating cavities 820 found in the bottom of the prosthesis and into which the prosthetic shoes will be subsequently placed and permanently adhered. The various data points may be further employed to create a model 810, and ultimately an actual prosthetic 910. FIGS. 10A and 10B are exemplary digital images illustrating the final removable prosthesis design, and including the prosthetic shoes (outlined in FIG. 10B) permanently transferred and affixed within the cavities. Moreover, prosthetic 810 may further include one or more “bars” 1020 (e.g., FIG. 10B) that not only provide a rigid interconnection between an adhesion surface for the prosthetic shoes themselves, but also provide a surface on which the balance of the fixed bridge prosthesis can be built or adhered to. Bar 1020 may be formed using the output of the dental CAD/CAM system and either machined directly or 3D printed and then cast in metal (e.g., investment casting) or other suitable rigid composite material, and then finished. In one embodiment, some or all of prosthesis 810 may be formed from one or more metals and other compatible materials known for use in the creation or replacement of dentures, including polymethyl methacrylate (PMMA) and the like. Finally, as represented by FIG. 11, the model is completed by fitting the prosthesis 810 onto the shoes 116, depicted as fastened to the implants.

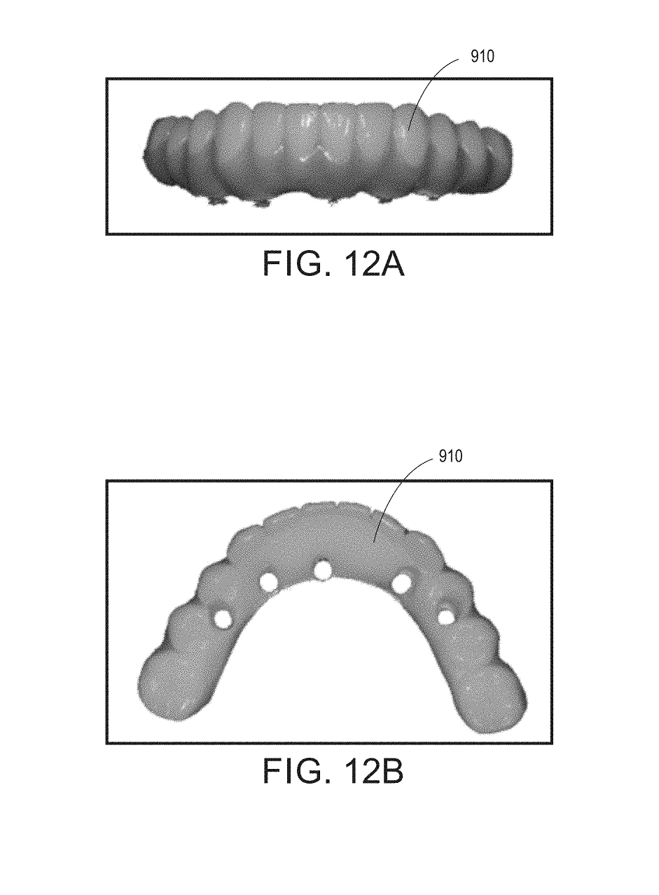

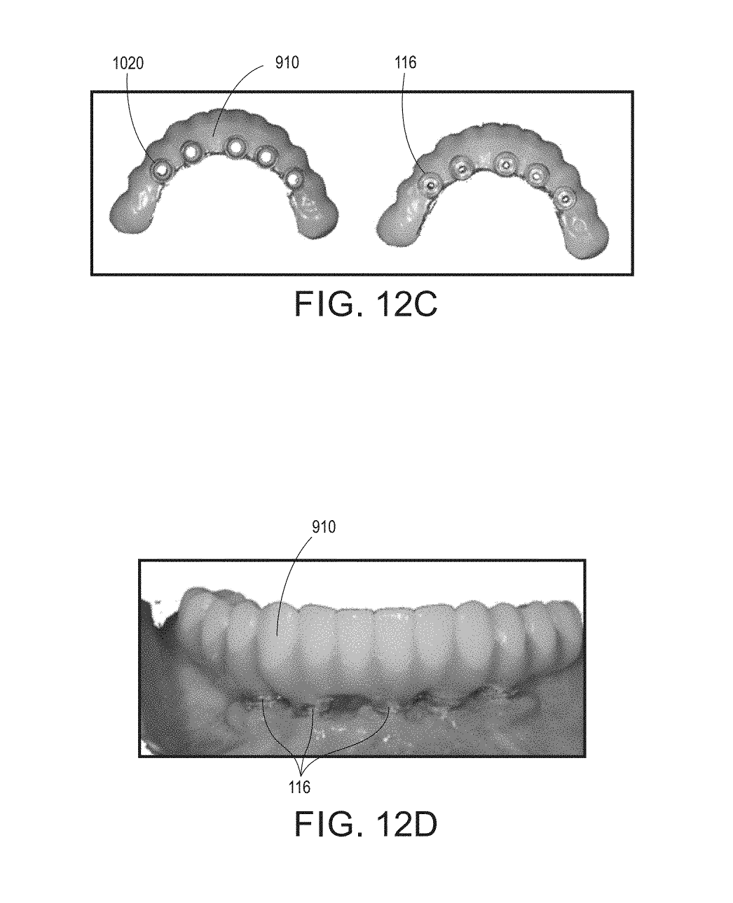

A final prosthetic (bridge), as designed, is depicted in FIGS. 12A-12D. FIG. 12A depicts the front view of the bridge 910, and FIGS. 12B and 12C respectively depict the top and bottom views of the bridge. In particular, the right side of FIG. 12C illustrates the prosthetic bridge with the prosthetic shoes cemented or adhered therein. Thus, FIG. 12C provides a comparison of the bridge without the shoes (left), and with the prosthetic shoes installed (right), creating the final fitting surface on which the fixed implant bridge will sit on top of the implants. FIG. 12D shows the bridge 910 installed in a patient's mouth, and the bottom of the bridge can be seen to be attached to the implants via the prosthetic shoes 116 that are at the gingival surface.

Also contemplated is the use of two sets of prosthetic shoes where a first set is employed as described to facilitate imaging and installation of a temporary prosthetic using the disclosed healing sleeves or caps. Then, upon completion of the permanent dental prosthetic, for each dental implant the first prosthetic shoe is removed from the implant, and the shoe or an identical, second prosthetic shoe is employed and is permanently adhered to the permanent dental prosthetic, and the prosthetic shoe is then used for attachment of the dental prosthetic to the dental implant using a fastener such as a threaded screw. It will be appreciated that the nature and configuration of the fastener is dictated by the type of implant(s) being employed. In other words, the prosthetic shoe starts out attached to the implant for imaging and healing after the implant is installed, and then the shoe (or an identical equivalent) ends up being the means by which the full prosthesis is attached to the implant. The prosthetic shoe becomes an integral part of the prosthesis once it is adhered.

Another advantage of the use of the disclosed healing apparatus, particularly including a bulb-shape on the top thereof is that a temporary prosthesis may be adhered to the healing sleeve with the bulb-shaped top providing a surface for improved retention and stability of the prosthetic tooth set-up. In summary, the disclosed healing assembly provides advantages in indexing of the implant position, healing, imaging of the implant and the associated prosthetic shoe, and the reuse of the prosthetic shoe by allowing it to be permanently affixed to the prosthesis and thus serving as the means by which the prosthesis is attached to the implants.

In summary, one method for installation of a fixed bridge-type dental prosthesis within a patient's mouth, includes inserting multiple dental implants 114 into the patient's alveolar tissue 140 (mandible or maxilla), and attaching a prosthetic shoe 116 to each of the dental implants using a center screw through the prosthetic shoes each having a tapered exterior surface with at least one annular groove. To each of the prosthetic shoes, a healing sleeve 118 is temporarily affixed. At one end the healing sleeve has a generally cylindrical outer surface and a tapered interior surface, where the taper matches that of the prosthetic shoes when said healing sleeves are affixed thereon. In addition to the several uses made of the prosthetic shoes and healing sleeves, the combination further prevents the post-insertion overgrowth of gingival tissue over the implants.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A healing assembly, for use in procedure in which a dental implant is installed in a patient's alveolar tissue, comprising:
a prosthetic shoe for attachment to the dental implant; and
a healing sleeve, removably mated with said prosthetic shoe, said healing sleeve having a generally cylindrical outer surface on a least a portion thereof.

2. The healing assembly according to claim 1, wherein said prosthetic shoe and said healing sleeve each have at least one mating surface feature to assure the relative position of the healing sleeve to the prosthetic shoe.

3. The healing assembly according to claim 2, wherein the prosthetic shoe is tapered on at least one exterior surface thereof and where the at least one mating feature includes a tapered interior surface on the healing sleeve, said tapered interior surface generally matching the taper of the exterior surface of said prosthetic shoe.

4. The healing assembly according to claim 1, wherein said prosthetic shoe includes at least one annular groove about an outer surface thereof.

5. The healing assembly according to claim 4, wherein said prosthetic shoe is reusable for attachment of a prosthesis to the dental implant, and where said at least one annular groove provides a surface by which the prosthetic shoe may be permanently adhered to the prosthesis.

6. The healing assembly according to claim 1, wherein said prosthetic shoe is reusable for attaching a prosthesis to the dental implant.

7. The healing assembly according to claim 4, wherein said healing sleeve includes at least one engagement feature, whereby upon pushing the healing sleeve over the prosthetic shoe, the at least one engagement feature seats in the annular grove of the shoe to removably attach the healing sleeve to the prosthetic shoe.

8. The healing assembly according to claim 1, wherein the prosthetic shoe and healing sleeve are mated in a snap-together relationship.

9. The healing assembly according to claim 1, wherein said healing sleeve is made from a non-metallic material.

10. The healing assembly according to claim 9, wherein said non-metallic material is radiographically translucent.

11. The healing assembly according to claim 9, wherein said non-metallic material is radiographically opaque.

12. The healing assembly according to claim 1, wherein said healing sleeve includes a bulb-shaped outer surface on one end thereof.

13. The healing assembly according to claim 1, wherein attachment of the prosthetic shoe to the dental implant includes at least temporarily attaching said prosthetic shoe to the dental implant using a fastener.

14. The healing assembly according to claim 1, wherein said prosthetic shoe includes at least one annular groove about an outer surface thereof, and said healing sleeve includes at least one engagement feature protruding from an interior surface, whereby upon forcing the healing sleeve over the prosthetic shoe, the at least one feature engages the annular grove of the prosthetic shoe to removably attach the healing sleeve to the prosthetic shoe.

15. The healing assembly according to claim 1, wherein said generally cylindrical outer surface of said healing sleeve includes an annular groove adjacent a radiused top portion of the healing sleeve outer surface that forms a bulbous top on the healing sleeve outer surface.

16. The healing assembly according to claim 7, wherein said one feature on said healing sleeve includes at least one bump on the interior surface thereof to frictionally engage the annular grove of the prosthetic shoe.

17. The healing assembly according to claim 7, wherein said one feature on said healing sleeve includes an annular ridge on the interior surface thereof to frictionally engage the annular grove of the prosthetic shoe.

18. The healing assembly according to claim 1, wherein each of the components of the healing assembly, with the exception of said healing sleeve, are made from radio-opaque materials.

19. The healing assembly according to claim 1, wherein for each dental implant the prosthetic shoe is removed when the healing sleeve is removed, and where a second prosthetic shoe is permanently adhered to a dental prosthetic and used for attachment of the dental prosthetic to the dental implant.

20. The healing assembly according to claim 1, further including at least one attachment located between the implant and the prosthetic shoe, such that the attachment provides spacing or a change of orientation angle between the implant and prosthetic shoe.

21. The healing assembly according to claim 20, wherein said at least one attachment includes a tissue collar between the implant and prosthetic shoe.

22. An apparatus, for use in a dental implant procedure, comprising a healing cap, said healing being suitable for removable mating with a prosthetic shoe that may be attached to a dental implant, said healing cap including:
a generally cylindrical outer surface on a least a portion thereof, said cylindrical outer surface including a first annular groove about a bottom portion of the healing sleeve outer surface, and a second, larger annular groove adjacent a radiused top portion of the healing sleeve outer surface to form a bulbous top on the healing cap outer surface,
at least one interior mating surface feature to assure a relative position of the healing cap to the prosthetic shoe, where the at least one mating feature includes a tapered interior surface on the healing cap, said tapered interior surface generally matching a taper of an exterior surface of said prosthetic shoe; and
at least one feature protruding from an interior surface of said healing cap, said at least one feature suitable for engaging a feature of the prosthetic shoe to removably attach the healing cap to the prosthetic shoe.

23. An apparatus for use with a plurality of dental implants inserted as a precursor to the attachment of a fixed bridge to said dental implants, comprising:
a prosthetic shoe for attachment to each dental implant; and
a healing sleeve, removably mated with said prosthetic shoe, said healing sleeve having a generally cylindrical outer surface,
wherein said prosthetic shoe and said healing sleeve each have at least one tapered mating surface feature to assure the relative position of the healing sleeve to the prosthetic shoe, where the prosthetic shoe is tapered on at least one exterior surface thereof and where the one mating feature includes a tapered interior surface on the healing sleeve, said tapered interior surface matching the taper of the exterior surface of said prosthetic shoe.
